(19) United States
(12) Patent Application Publication
(10) Pub. No.: US 2025/0225198 A1
(43) Pub. Date: Jul. 10, 2025

(54) LARGE PARAMETER SET COMPUTATION ACCELERATOR USING MEMORY WITH PARAMETER ENCODING

(71) Applicant: Taalas Inc., Toronto (CA)

(72) Inventors: Ljubisa Bajic, Toronto (CA); Dragoljub Ignjatovic, North York (CA); Lejla Bajic, North York (CA)

(21) Appl. No.: 19/014,806

(22) Filed: Jan. 9, 2025

Related U.S. Application Data
(60) Provisional application No. 63/619,662, filed on Jan. 10, 2024.

(51) Int. Cl. G06F 17/16; G06F 12/02

(52) U.S. Cl. CPC G06F 17/16; G06F 12/0207

(57) ABSTRACT

Methods and systems for accelerating computational operations are disclosed herein. In some embodiments, a method includes multiplying, using a set of multiplier circuits, an input and a set of values associated with a set of parameters in a vector to produce a set of multiplier outputs. The method includes storing, in a set of readable cells, a set of addresses that is associated with the set of values of the set of parameters. The method also includes reading, using a read circuit, the set of addresses stored in the set of readable cells for provision to a selection circuit. The method further includes selecting, using the selection circuit, an output from the set of multiplier outputs corresponding to the set of parameters of the vector based on the set of addresses.

### CROSS REFERENCE TO RELATED APPLICATION

This application claims the benefit of U.S. Provisional Patent Application No. 63/619,662, titled “Large Parameter Set Computation Accelerator Using Memory with Parameter Encoding,” and filed on Jan. 10, 2024, the entire content of which is incorporated by reference herein.

### TECHNICAL FIELD

This disclosure relates to computational architectures, in particular, to computation accelerators (e.g., hardware accelerators) in large parameter environment.

### BACKGROUND

Machine learning is experiencing a remarkable surge in significance across various aspects of society. Machine learning or intelligence can be utilized to derive actionable insights from vast datasets, automate different tasks, and predict future trends with unprecedented accuracy. This enables entities that harness the power of machine learning to gain a competitive edge, while economies as a whole benefit from increased efficiency, greater productivity, and the emergence of new markets and opportunities. However, the rapid growth and surge in the activity of machine learning has also resulted in a substantial rise in the computational resources required and consumed by ML applications.

The escalating computational cost in ML applications poses a significant challenge in various technical fields. As ML models grow increasingly complex and datasets expand, the demand for computational resources continues to rise. Training deep neural networks, for example, may require immense amounts of processing power and memory, pushing the boundaries of available/existing hardware. This increase in cost impacts the affordability of model training, raises environmental concerns due to heightened energy consumption, and further creates a barrier to entry for smaller organizations and researchers with limited resources. Tackling this challenge involves advancements in efficient algorithms, improved parallelization techniques, hardware acceleration, and other innovative solutions.

ML computations often require a significant amount of matrix multiplications, which serve as a fundamental computation block across a wide range of models and applications. In fully connected neural networks, for example, matrices represent the weights and activations of interconnected neurons across various layers. These weights represent the learned model data of a neural network, obtained through a training process. During both training and inference, these matrices may be repeatedly multiplied to transform input data into meaningful predictions. The essence of deep learning lies in its ability to discern complex patterns by fine-tuning or refining these matrices through backpropagation, which is a process that also heavily relies on matrix multiplications. As models and data sets continue to expand, the scale of the required matrix multiplications grows proportionally, driving the need for specialized hardware and optimized algorithms to ensure efficient and timely execution of ML tasks.

### SUMMARY

To address the aforementioned shortcomings, methods and computing architectures used to accelerate computation operations are disclosed herein.

In some embodiments, a system for accelerating computational operations is provided. The system can be part of a system for multiplying a vector by a scalar input, a matrix by a scalar input, or a matrix by a matrix and any variant thereof. In some embodiments, the system may include a set of multiplier circuits configured to receive an input and generate a set of multiplier outputs based on multiplying the input with a set of values associated with a set of parameters in a vector. The system may also include a set of readable cells configured to store a set of addresses that is associated with a set of values of the set of parameters in an address space. The system may also include a read circuit configured to read the set of readable cells. The system may further include a selection circuit configured to receive the set of multiplier outputs and the set of addresses read by the read circuit, and produce an output using the set of multiplier outputs based on the set of addresses. In some embodiments, the selection circuit may include one or more multiplexers.

In some embodiments, a method for accelerating computational operations is provided. The method may include multiplying, using a set of multiplier circuits, an input and a set of values associated with a set of parameters in a vector to produce a set of multiplier outputs. The method may also include storing, in a set of readable cells, a set of addresses that is associated with the set of values of the set of parameters. The method may also include reading, using a read circuit, the set of addresses stored in the set of readable cells for provision to a selection circuit. The method may further include selecting, using the selection circuit, an output from the set of multiplier outputs corresponding to the set of parameters of the vector based on the set of addresses.

In some embodiments, a method for configuring a system for multiplication operation acceleration is provided. The method may include providing a set of readable cells. Each readable cell in the set of readable cells is uniquely associated with a parameter of a vector. The method may also include configuring a connectivity mesh to allow each readable cell in the set of readable cells to be coupled to a multiplier via the connectivity mesh. The multiplier is in a set of multipliers and inputted with a value of the parameter of the vector.

In some embodiments, a method for configuring a system for multiplication operation acceleration is provided. The method includes applying an input to a set of multipliers. The set of multipliers is coupled to a set of readable cells using a connectivity mesh, and each readable cell in the set of readable cells is: (i) uniquely associated with a parameter of a vector, and (ii) coupled, via the connectivity mesh, to a multiplier. The multiplier is in a set of multipliers and inputted with a value of the parameter of the vector. The method also includes reading, using a read circuit, a product of the input and the vector from the set of readable cells. In some embodiments, prior to applying the input, the connectivity mesh is configured in a manner that each readable cell in the set of readable cells is coupled, via the connectivity mesh, to the multiplier.

The system may be implemented in circuitry. The system may be implemented as an integrated circuit or one or more integrated circuits that are in communication with each other. The system may be a matrix multiplication accelerator. The system may include a controller such as a central processing unit, microcontroller, control circuit, or other controller that is capable of feeding operands to the matrix multiplication accelerator in order to accelerate computations involving large matrices.

The above and other preferred features, including various novel details of implementation and combination of elements, will now be more particularly described with reference to the accompanying drawings and pointed out in the claims. It will be understood that the particular methods and apparatuses are shown by way of illustration only and not as limitations. As will be understood by those skilled in the art, the principles and features explained herein may be employed in various and numerous embodiments.

### BRIEF DESCRIPTION OF THE DRAWINGS

The disclosed embodiments have advantages and features which will be more readily apparent from the detailed description, the appended claims, and the accompanying figures (or drawings). A brief introduction of the figures is below.

FIG. 1 illustrates an exemplary block diagram of a system for performing matrix multiplications, according to some embodiments.

FIG. 2 illustrates an exemplary block diagram of a system for multiplying a matrix by a scalar in which outputs are read bit serially, according to some embodiments.

FIG. 3 illustrates an exemplary block diagram of a system for multiplying a matrix by a scalar in which the outputs are output fully in parallel, according to some embodiments.

FIGS. 4A-4D illustrate an example matrix multiplication process, according to some embodiments.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Overview

As mentioned, the data structures involved in machine intelligence computations are growing in size at a remarkable rate. Modern neural network models may contain over a trillion parameters, each of which can be used in multiple computations during the execution of a model. Such computations often include matrix multiplications, where each individual matrix includes billions of parameters, and billions (if not trillions) of discrete multiplication operations may need to be computed to conduct a matrix multiplication with each individual matrix.

While an individual matrix may contain billions of parameters, the number of available values per parameter can be relatively limited in many applications. This limitation arises because the number of bits allocated to represent each parameter is typically constrained to minimize the memory and computational resources needed to store and execute a model. For example, 8-bit data types are often used in accelerator architectures for machine learning applications, but the 8-bit data types can represent at most 256 different values per parameter. Some accelerator architectures even utilize 4-bit data types, which can be used to represent at most 16 different values. Consequently, when dealing with a matrix having a billion parameters, it is comparatively simpler to multiply all the possible parameter values in the matrix by a number than to perform the same operation on every individual parameter in the matrix (e.g., multiply every parameter in the matrix by that number). From the perspective of traditional computation, this is an unconventional situation, as it is typically the case that the potential values for an unknown parameter far outnumber the unknown parameters themselves in a computation. However, this alternative approach to addressing the requirements of large matrix computations serves as the basis for several of the improvements in the systems and methods disclosed herein.

Specifically, methods and systems that include computational architectures for accelerating vector multiplications are disclosed herein. In some embodiments, the systems and methods may be applied to multiply matrices by expanding the amount of hardware used in the systems and/or by executing the methods iteratively for the multiple vectors of each of the matrices. The vectors and matrices may be multiplied by a scalar (e.g., a real number) in each iteration. Different portions of the vectors and matrices may be multiplied in each iteration. The vectors and matrices may contain a large set of parameters, with each parameter associated with a given value. As used herein, the term “parameter” refers to an element of a vector (e.g., the first element) while the term “value” refers to the actual value of a parameter (e.g., the first parameter of the vector [1, 0] has a value of 1). The set of parameters can be so extensive that it becomes more efficient to compute the multiplication of an input value (e.g., a scalar value) with all the potential values of the parameters to produce a set of multiplied values. An ordered set of addresses can then be used to select, in a corresponding order, the multiplied values associated with the parameters from the set of multiplied values. This approach allows the selected multiplied values to represent the product of the scalar with the vector while significantly reducing the number of multiplication operations being conducted.

In some embodiments, the systems and methods disclosed herein may include one or more of a set of multipliers, a set of readable cells, read circuit(s), and selection circuit(s). A multiplier may include a circuit used to perform the multiplication of two numbers (e.g., parameter values in a vector/matrix and a scalar input value). A readable cell may refer to a storage element for storage and synchronization of data (e.g., parameter values). The set of readable cells may include multivibrators such as flip flops or latches. The set of readable cells may also be a high-density memory such as a read only memory. A read circuit is typically a circuit used to retrieve or access data from a memory storage element or device (e.g., readable cells). In this disclosure, the read circuit may be a standard read circuit for high density memory, which can be used to select from which readable cells to read data and provide the outputs of the selected readable cells to a selection circuit. A selection circuit is a type of circuit used to choose one or more signals, data lines, or inputs based on certain conditions or control signals in various applications (e.g., multiplexing, memory addressing, and data routing), ensuring the data or signal processing at any given time. In some embodiments, the selection circuit of the present system may utilize multiplexers.

It should be noted that, in the systems and methods disclosed herein, the same term will be used for a signal line that is dedicated to a specific signal and for the signal itself. For example, the term “multiplier output” can be used to refer to the signal line that provides the output of a multiplier and the value of the signal provided on that signal line. In addition, the terms “multiplier” and “multiplier circuit” may be interchangeably used in the description hereafter.

In some embodiments, the set of multipliers may be hardwired to multiply every possible value for the parameters of a vector by an input value. The set of multipliers may receive the input (including parameter values and input value) and generate a set of multiplier outputs. For example, a multiplier or multiplier circuit may be a hardware implementation that uses an array of AND gates and adders to multiply two numbers. Each multiplier in the set of multipliers may be associated, in a one-to-one correspondence, with a value in the set of possible values for each parameter of the vector. That is, cach multiplier circuit may be configured to receive an input value (e.g., a scalar) and a unique value from the set of parameter values of the vector to perform the multiplication computation. The values that are fed into each individual multiplier in the one-to-one correspondence can be referred to herein as a set of multiplier values. The set of multiplier outputs may be the products of the set of multiplier values as multiplied by the input value. The set of multipliers can therefore provide a set of multiplier outputs equivalent to the input value multiplied by the set of multiplier values.

The set of readable cells, the read circuit, and the multipliers use the received values as the operands to determine multiplication. The selection circuit may be configured to order the multiplier outputs to obtain a product of a vector/matrix and an input value. In some embodiments, the set of readable cells may be associated with a set of parameters of the vector and store a set of addresses. The set of addresses may be associated with a set of values of the parameters in an address space. The selection circuit may utilize the address space to select certain values from the input based on the addresses and pass the selected values to the output. For example, the multiplier outputs from the set of multiplier circuits may be provided as inputs to the selection circuit, and the read circuit reads the addresses from the readable cells in a particular order and applies the addresses to the selection circuit. In response, the selection circuit may select at least a subset of the multiplier outputs based on the applied address, and output the selected multiplier output values. The output values are associated with the parameters of the vector as multiplied by the input in the desired order.

In some embodiments, the input values may be values that are part of another vector (c.g., a second vector). These input values may be provided to the system (c.g., along with the first vector to a multiplier) in series to aid in the computation of a multiplication of the two vectors. The output values read from the selection circuit may be accumulated after each read operation to achieve this result.

In some embodiments, the system for vector multiplication can be part of a system used for matrix multiplication. For example, the set of readable cells may be divided into subsets of readable cells, where each subset is uniquely associated with a row or column of a matrix. The subsets of readable cells may be independently addressable and readable, such that an output matrix may be assembled from a series of output values generated by the addresses in those subsets of readable cells.

The ability to program the values in the set of readable cells and to control the order in which the read circuit accesses the values enables the system to function as a computational structure tailored for specific matrices. In machine intelligence applications, for example, the model data of a machine intelligence application (e.g., data generated and learned from the training and inference phases) may be used to program the addresses in the set of readable cells. Since the model data typically does not change after training, a trained model may be deployed into such a system to provide an efficient means for executing the model. Furthermore, the same system can be re-configured for a different trained model by simply changing/updating the addresses stored in the set of readable cells. In some embodiments, approaches used for mask read-only-memory (ROM) can be applied to program the values stored by the readable cells, for example, by employing different high level metal wiring masks that are customized to a specific model. Accordingly, adapting the system for a particular model (e.g., modifying the system for a specific model) may involve encoding or saving the model in the system's mask ROM, providing a streamlined and efficient means of customization.

In some embodiments, the set of multipliers may output digital or analog values that represent the output of multiplication operations. The analog values may be represented by different reference voltage that extends from the ground to a supply voltage. The digital value may be serialized pulse trains or any other type of digital encoding. For example, the set of multiplier circuits may include serializers, and the outputs from the selection circuit may be coupled to a deserializer. A serializer can convert data from a parallel format into a serial format (e.g., from 4-bit data to four 1-bit data), and a deserializer performs the reverse operation. In another example, the set of multiplier circuits may be bit-serial multipliers, and the outputs from the selection circuit may be coupled to the bit-serial adders or multipliers.

In some embodiments, the digital signals may be transmitted to the selection circuit in advance, so that the signals are available to be read from the outputs of the selection circuit once the selection circuit is configured according to the applied addresses. In alternative embodiments, digital signals may be transmitted to the selection circuit at the same time the selection circuit is configured by applied addresses, thereby reducing the unnecessary transmission of signals through the system. For example, a command instructing the selection circuit to pass a specific selection of inputs to its outputs could concurrently trigger all the multipliers to each output a serialized digital value, which can then be transmitted through the selection circuit to the outputs.

The readable cells, associated with a single vector or multiple vectors, may be read in various ways. For example, a set of readable cells associated with a vector may be read in parallel, to obtain the result of multiplying all the values in a vector by an input value in a single read operation. In another example, a set of readable cells associated with a vector may be read in parallel and multiple times, to obtain the result of multiplying all the values in the vector by the input values in a sequence or order of read operations when different values are applied as the input values. The set of readable cells may also include subsets of cells associated with different vectors. The subsets of cells may be organized in a way that the cells can be read independently. For example, the set of readable cells can be configured like a memory array, and the subsets of cells can each be associated with separate word lines such that all the values associated with the subset can be read in parallel.

In some embodiments, cach set of outputs read from the selection circuit in response to a given set of applied addresses can be applied to an accumulator, which can then accumulate the outputs obtained during that sequence of read operations.

In some embodiments, the present system may be applied to accelerate vector computation, in particular, accelerate multiplication involving an input and a vector. In some embodiments, the input may be a scalar value. Each multiplier in the set of multipliers may receive two operands. The first operand may be the scalar value, which is shared by all the multipliers in the set of multipliers. The scalar is a single numerical value representing magnitude such as distance, speed, time, temperature, length, etc. The second operand may be a different value of the parameters of the vector. The second operand can be unique for each multiplier and is referred to as a multiplier input value. The second operands or multiplier input values could all be different and be drawn from a set of potential values for the parameters in the vector.

There may be a multiplier for every potential value for the parameters in the vector. For example, in a scenario where the parameters are represented by 4-bit values, there may be 16 multipliers. However, in certain embodiments, one of the values (e.g., two operands) can be zero or one. In such cases, two multipliers are not needed because the zero-multiplier equivalent can only produce a zero value (e.g., 0×X=0), and the one-multiplier equivalent can only pass the first operand (e.g., X×1=X). The set of multipliers receives vector parameters as input values (e.g., the second operands), where the different values of parameters are delivered to each multiplier for the multiplier to execute a multiplication using the values as operands. The input (e.g., the first operand) may also be a vector and, in some embodiments, a controller may be configured to provide the independent scalar values of the vector to the multipliers in sequence.

In some embodiments, the present system may be part of a large system that is used to accelerate matrix-based computation, as described below. In these embodiments, a set of readable cells may be organized in rows and columns with each cell being uniquely associated with a parameter of a matrix. A controller circuit may provide multiple input values to the set of multipliers, read the resulting output values using the selection circuit, and accumulate the output values in specific patterns to produce the result of matrix multiplication. The controller circuit may be configured to read certain subsets of the readable cells in a particular order, to obtain the result of the matrix multiplication from the selection circuit.

In some embodiments, a method for accelerating multiplication operations can be summarized as follows. First, a set of multiplier circuits may be used to multiply an input and a set of values to produce a set of multiplier outputs. The set of values is associated with a set of parameters in a vector, which may be a column or a row of a matrix. The input may be a scalar value or a value extracted in order from a vector or even a matrix. Therefore, vector multiplication operations may be repeated and accumulated to achieve a matrix multiplication.

In some embodiments, the set of multipliers may be associated with every value in the vector in a one-to-one correspondence. In other embodiments, the set of multipliers may be associated with every value in the vector in a one-to-one correspondence. This is particularly beneficial when there is a large set of parameters but the parameters vary in a limited range. For example, in ML applications, billions of parameters may be represented by a set of 2ⁿ unique values, where n is a small positive integer such as 2, 3, or 4. The multiplier circuits may be designed to perform multiplications 4, 8, or 16 times (e.g., 2ⁿ times) instead of multiplying with the billions of parameters. The number of 4, 8, or 16 may be further reduced in zero or one operand cases. The multiplication operation is therefore substantially accelerated.

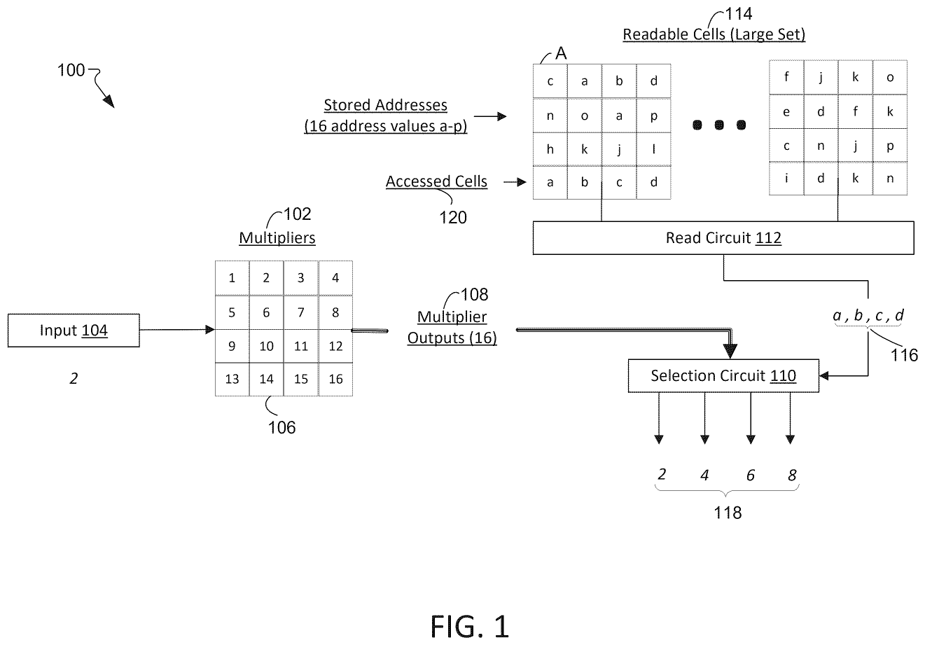

In addition to the multiplier circuits, a set of readable cells (e.g., memory or storage elements) may also be applied to store a set of addresses, which is associated with the set of values of the set of parameters in the vector. A read circuit is used to read one or more addresses stored in the set of readable cells for provision to a selection circuit. The selection circuit may then be used to select, from the set of multiplier outputs, a multiplication output corresponding to the set of parameters of the vector based on the one or more addresses read by the read circuit from the set of readable cells. The methods and systems for implementing multiplication operation acceleration are described in detail below with reference to FIGS. 1-4D.

### System Implementation

FIG. 1 is a block diagram of system 100 for accelerating matrix multiplications. In the illustrated system 100, a set of multipliers or multiplier circuits 102 may take an input value 104 and a set of multiplier input values 106 for performing multiplication operations. Here, the input value of “2” at 104 serves as a scalar input to be multiplied by all the parameters of the matrix 106 to generate multiplier outputs 108. A selection circuit 110 is input coupled to the multiplier outputs 108 and control coupled to a read circuit 112. That is, selection circuit 100 has data input from multiplier outputs 108 and control input from read circuit 112. Multiplier outputs 108 are inputted to selection circuit 110, which, under the control of read circuit 112, may generate an output (e.g., output 118). Read circuit 112 may read a set of readable cells 114 and provide the control to the selection circuit 110.

In some embodiments, system 100 is preconfigured to accelerate multiplications of an input value 104 with a known matrix 106. The known matrix 106 is effectively represented by the multiplier inputs to the set of multipliers 102, as well as the addresses stored in readable cells 114. In the illustrated example of FIG. 1, the values of each parameter of matrix 106 may be represented by four bits such that there are 16 potential values for each parameter in the matrix. In this scenario, each of the four-bit values or addresses stored in readable cells 114 may have a one-to-one correspondence with a numerical value, where each stored values may be treated or interpreted as a numerical value. As a result, each parameter will have exactly 16 values. Alternatively, there may be only 16 different values of the parameters in the matrix such that there are only 16 potential values of all the parameters in the matrix. The “potential” values indicate the correspondence between the addresses and numerical values may not be a one-to-one correspondence. A numerical value pointed to or represented by an address in each readable cell 114 may be determined using a lookup table. In this example, there may be 16 addresses stored in readable cells 114. The 16 addresses may point to one or more but less than 16 numerical values (e.g., integers, floating point values, etc.) depending on the configuration of the lookup tables. For example, all the lookup tables can refer to one value only, or two values, or three values, . . . , up to at most 16 values. Regardless, the potential values are associated with multipliers in the set of multipliers 102, and these values can be labeled 1 through 16, as depicted. As discussed above, two of the illustrated blocks (e.g., 16 matrix entries) do not physically need a multiplier as they can be associated with a value of 0 or a value of 1, both of which do not require a multiplication operation to obtain the product.

The order in which the parameters occupy matrix 106 may correspond to or be associated with a position in a large set of readable cells 114. In the illustrated case of FIG. 1, the set of readable cells 114 is a 4-by-X set of cells, in which each cell is associated with a parameter of a 4-by-X matrix. In some embodiments, the association between cells in the set of readable cells 114 can be incorporated into the logic of read circuit 112 and its corresponding controllers. It is not necessary for the physical dimensions of the set of readable cells 114 to be identical to that of the matrix 106. The dimension of matrix 106 is represented by the values stored in the set of readable cells 114. However, in the illustrated case, the position of the readable cell in the set of readable cells 114 corresponds with the position of a parameter in the matrix 106.

The readable cells store a set of addresses. In some embodiments, the set of readable cells 114 stores a set of addresses that is associated with the values of the parameters of matrix 106 in an address space. In the illustrated example, the addresses are values “a” to “k” in readable cells 114, which are in a one-to-one correspondence with the numerical values “1” to “16” in matrix 106. For example, the address “b” may be associated with a value of “2.” The address space is used by selection circuit 110 to select the inputs, from multiplier outputs 108, that are associated with the addresses. In the illustrated example, the addresses “a, b, c, d” in 116 are being read from memory (e.g., accessed cells 120) and applied to selection circuit 110. As a result, selection circuit 110 may select the multiplier outputs 108 associated with multiplier input values “1, 2, 3, 4.” The selected multiplier input values will be multiplied by the scalar input of “2” at 104 using the set of multipliers 102. As illustrated, the final outputs are “2, 4, 6, 8” at 118, which is equal to the values “1, 2, 3, 4” multiplied by 2.

Using this approach, and by repeatedly reading different addresses from readable cells 114, the product of input “2” at 104 multiplied by all the values of the stored matrix 106 can be assembled. The present approach is particularly beneficial in large matrix multiplication acceleration. For example, in a specific embodiment, when the “X” value for the dimension of the matrix is greater than 1,000, the number of required multiplication operations decreases from 4,000 to 14, dramatically accelerating the required computations. In some embodiments, the multiplication operations for a large parameter set computation effectively condense to the task of reading the appropriate values from memory using read circuit 112 and selection circuit 110.

### Multiplication (Vector-based) Mechanism

An example in which each readable cell in a set of readable cells 114 is uniquely associated with a parameter of a vector can be explained with reference to a vector consisting of parameters {X, Y, W, Z}. Suppose the set of readable cells 114 of system 100 is configured to accelerate a multiplication using a vector that has a cardinality of four. There would be four different readable cells A, B, C, and D in the set 114, with each being associated with the parameters X, Y, W, and Z respectively. Each of the readable cells A, B, C, and D would store an address for the value of a corresponding parameter in an address space of selection circuit 110. For example, readable cell A shown in FIG. 1 may store an address for the value of parameter X in an address space of selection circuit 110. As such, when selection circuit 110 is provided with the address from readable cell A, selection circuit 110 may be able to select the value of parameter X from the provided input to generate a corresponding multiplication output.

In some implementations, the number of readable cells 114 may be configured to be equivalent to the number of parameters in a neural network matrix. For example, the number of readable cells 114 in an integrated circuit implementation can be on a gigabyte scale, and readable cells 114 are uniquely associated with billions of parameters. The set of readable cells 114 is associated with the parameters (e.g., in the vector {X, Y, W, Z}) in a one-to-one correspondence, and the readable cells 114 are ordered to match the order of the parameters in the vector. Notably, the readable cells 114 are not associated directly with the values for the parameters but, instead, are associated with the parameters X, Y, W, and Z themselves. In other words, the readable cells 114 are each associated with an entry of the vector and are ordered to match the order of those entries.

Another example can be explained with reference to the same vector consisting of the parameters {X, Y, W, Z}, which respectively have values {1, 2, 3, 4}. Here, the addresses from readable cells 114 are provided to a selection circuit 110, and the selection circuit 110 is coupled to a set of multipliers. In this example, there are four multipliers that are input coupled to the values 1, 2, 3, and 4 respectively (e.g., cach multiplier receives a respective multiplier input value 1, 2, 3, and 4). The same four multipliers also receive an input (e.g., input 104) that will be used to multiply the vector. In this example, readable cells 114 also includes four cells A, B, C, and D. Readable cell A can be associated with parameter X and coupled via a connectivity mesh to one of the four multipliers that is input coupled to 1. Readable cell B can be associated with parameter Y and provide an address “b” to selection circuit 110 to pass through a multiplier output from another of the four multipliers that is input coupled to 2. The same pattern continues for readable cells C and D. The four multipliers in this example form a set of multipliers.

A connectivity mesh includes a specific type of interconnection topology used to link various components (e.g., multipliers, readable cells, read circuit(s), selection circuit(s), etc.) within a system or integrated circuits. The mesh configuration is often used in high-performance systems (e.g., System-on-Chip (SoC), Network-on-Chip (NoC) designs, advanced memory architectures, etc.) to improve communication, performance, and scalability. In some embodiments, the connectivity mesh may be designed to be configurable when the present system is operational. In other embodiments, the connectivity mesh may be configurable when the system is fabricated. In some embodiments, the present system may be implemented on an integrated circuit, and the connectivity mesh may be formed in the metal layers of the integrated circuit. In such cases, the metal layers create the wiring and thus provide the physical infrastructure for interconnecting between the different components of the system.

In some embodiments, a set of multipliers (e.g., 102) may include a multiplier for every potential value of the parameters. For example, if the parameters (e.g., X, Y, W, and Z) have a single-digit value, the set of multipliers may include 10 multipliers, where each multiplier may use one of the values from zero to nine as input. In practical implementations, the multiplier that was input coupled to zero (e.g., the multiplier input is zero) may be connected to ground or another constant representation of zero, since the multiplication computation is independent of the input in this case and is always zero. Alternatively, for both zero and one input, the present system (e.g., system 100) may not apply a multiplier. Instead, the present system may simply route a zero or null value to the selection circuit 110 or allow an input circuit to pass the multiplier input directly to the selection circuit 110.

The cardinality of the set of multipliers (e.g., 102) can be configured to be different values in different applications. In some embodiments, the set of multipliers 102 may be associated with every value in a vector in a one-to-one correspondence. For example, in a vector with 1,000 parameters and 57 unique values, the set of multipliers may include 57 multipliers with each multiplier being uniquely associated with one of the 57 unique values. In other embodiments, the set of multipliers 102 may be associated with every potential value of a parameter in the vector. For example, in a vector with one trillion parameters and cach parameter is one of 50,000 unique values, the set of multipliers 102 may be a set of 50,000 multipliers with each multiplier being uniquely associated with one of the 57 unique values. In yet other embodiments, the set of multipliers 102 may include a multiplier for every potential value of the parameters as determined by the resolution of the data type used to represent the parameters. For example, if the parameters were represented by a 4-bit data type, there may be 16 multipliers in the set of multipliers 102. If the parameters were represented by a 16-bit data type, then the set of multipliers 102 may include 65,536 multipliers. In some embodiments, the parameters in a vector are n-bit values, and the set of multipliers has a cardinality of two to the power of n (2ⁿ). In some embodiments, the cardinality of multipliers 102 may be configurable. The present system may alter the number of multiplication operations that are conducted based on at least one of a particular matrix configured in the system or a particular data type used to represent the values of the parameters.

The multiplier input values/inputs may be provided in various ways in different applications. The multiplier inputs may include a set of fixed inputs and an input value. For example, the set of fixed inputs may be the values of the parameters in the vector (e.g., in 106) that will be multiplied, and the input value (e.g., 104) may be the value that the vector will be multiplied by. In some embodiments, the input value (e.g., 104) may be provided by a controller. The controller can be a higher-level controller that orchestrates the multiplication of two vectors or two matrices, in which the scalar-vector multiplication is a single part. In some embodiments, the set of fixed inputs (e.g., in 106) may be hard-coded into the circuitry of the present system (e.g., system 100) in various ways. For example, the fixed inputs (e.g., in 106) may be integrated into the logic of each multiplier (e.g., in set 102) so that each multiplier can be configured to only receive a single true input value. In addition, cach multiplier (e.g., in 102) may have a slightly different connectivity or logic structure so that each multiplier can be optimized for multiplication via a given value. In another example, the fixed inputs may be stored in hard-coded registers. The fixed inputs can be supplied to a multiplier (c.g., in 102) in the same manner as a standard input being provided to a multiplier circuit, except that only the same value can be provided to one input of the multiplier circuit.

Suppose a vector or matrix is stored in readable cells (e.g., a static random access memory (SRAM)), with each element of the vector/matrix being associated with a four-bit value. As discussed above, the four-bit values may be treated as datums or numerical values such as 0, 1, . . . , 15 or −8, −7, . . . ,7 (e.g., when the addresses are mapped to the numbers using a one-to-one correspondence). The four-bit values may also be considered as addresses or pointers to a lookup table, where each of the addresses may map to a different numerical value or a same value. The mapped values may be integers, floating point values, etc. The multiplier described herein, which multiplies an input with this numerical value can have one programmable input and another fixed input (i.e., 0, 1, . . . , 15 or −8, −7, . . . ,7), particularly in scenarios such as when each four-bit value/address is viewed as the number itself (e.g., based on a one-to-one correspondence). Using the fixed inputs in the present system can allow for simplification of the multiplier design, reducing the need for complex arithmetic operations. This leads to a smaller circuit area, lower power consumption, and faster performance, making it a highly efficient approach in many applications, especially in low-power or area-constrained environments.

While the use of fixed inputs is beneficial for a multiplier to achieve significantly lower area, better power efficiency, etc., the present system supports both a multiplier with a fixed input and another programmable input (e.g., in the scenarios where one-to-one correspondence may be applied) as well as a full multiplier with only programmable inputs, depending on various configurations and needs associated with different applications.

The multipliers in the set of multipliers 102 may adopt different forms/configurations depending on a specific application. In some embodiments, the set of multipliers 102 may include standard digital multiplier circuits, which are selected to operate with inputs that have data types of the values of the vector. For example, the multipliers can be configured as two-operand, 4-bit floating-point multipliers. The multipliers can be clocked or static logic circuits. In other embodiments, the set of multipliers 102 may be a mixed signal or analog circuit block that outputs an analog current or voltage signal to represent a multiplication output. For example, the voltage or current between zero and supply voltage/current may be divided into a large number of values to represent multi-bit values. The set of multipliers 102 may accordingly output a set of analog reference voltages or currents to the selection circuit 110.

In addition to the circuitry that conducts the operand multiplications in different applications, the multipliers in the set of multipliers 102 may include ancillary circuitry. In some embodiments, the set of multipliers 102 may include a set of serializers to serialize the output values for transmission to the selection circuit 110. The serializer can convert a digital value into a sequence of pulses or transform an analog signal into a series of pulses with varying amplitudes, where each pulse represents a multi-bit analog signal. In such cases, the output circuitry (not shown in FIG. 1) that is configured to read the product values from selection circuit 110 may include a set of deserializers to resolve the values read from selection circuit 110. In some embodiments, the set of multipliers 102 may also include a set of amplifiers to amplify the output values.

In some embodiments, the multipliers in the set of multipliers 102 may be bit serial multipliers. The output circuitry that reads the product values from selection circuit 110 may be coupled to one or more adders or accumulators that are configured for bit serial operations. An adder is a digital circuit that performs the addition of numbers, and an accumulator is an adder combined with storage capability to retain the result of the addition. The multipliers 102 may provide signals to the selection circuit 110 in a bit-serial manner and transmit the signals as they are calculated. The accumulators and adders may receive the signals from the selection circuit 110 and add or accumulate the values as they are received. For example, a parallel adder can operate bit-serially on all the values being read from selection circuit 110 to calculate an output vector as the bits are received from selection circuit 110.

### Selection Mechanism

A selection circuit (e.g., 114 in FIG. 1) may take on various characteristics in different applications. The selection circuit 110 may operate according to an address space. The address space may define what inputs should be selected such that the corresponding multiplication results will be output from selection circuit 110. In some embodiments, selection circuit 110 uses multiplier outputs 108 as data input. In addition, selection circuit 110 also includes a control input that operates based on the address space. When an address is provided as the control input to the selection circuit 110, this enables a selection of at least a subset of the data input (e.g., 108) corresponding to that address in the address space to be provided to the output of selection circuit 110. In other words, selection circuit 110 may be configured to pass a fixed number of inputs (e.g., 108) to the output (e.g., 118) at a given time in response to one or more addresses (e.g., 116) received on the control input of the selection circuit 110.

For example, in the example of FIG. 1, selection circuit 110 may select four inputs at a time in response to receiving four addresses in 116. The four selected inputs are then forwarded to the outputs (e.g., output circuitry) in the same order as the provided addresses. Specifically, from the 16 multiplier outputs 108 that are provided to the input of selection circuit 110, selection circuit 114 can select the first input “2” to output on the first output, the second input “4” to output on the second output, the third input “6” to output on the third output, and the fourth input “8” to output on the fourth output in response to the signal “a, b, c, d” provided on the control input 116. In some embodiments, the number of data inputs to the selection circuit 110 may depend on the number of multiplier outputs 108 used in a given system (e.g., 100). The number of outputs from selection circuit 110 may depend on the number of readable cells 114 that are accessed in each cycle of the system's operation.

### Data Read Mechanism

The readable cells (e.g., 114 in FIG. 1) can take on different characteristics depending on the specific application. The readable cells may be implemented in ROM, programmable read only memory (PROM), electrically erasable programmable read only memory (EEPROM), flash memory, cross-point memory, random access memory (RAM), mask ROM, or any kind of memory. The readable cells may be registers, latches, or flip-flops.

In some embodiments, the set of readable cells 114 may be configured to be read in a manner that allows the stored addresses associated with parameter values to be read in parallel and resolved by selection circuit 110. For example, the readable cells may each be associated with a parameter value from a vector. The readable cells may be organized into subsets, where each subset of readable cells represents all the values of a parameter. Multiple subsets of readable cells may collectively form a larger set of readable cells, representing an entire matrix. Additionally, the readable cells may be part of a set of readable cells 114 that encompasses all the available readable cells in a given integrated circuit or a particular block of circuitry within the integrated circuit. For example, a particular block of circuitry may include an array of readable cells, which is of a dimension with one billion readable cells by 1,000 readable cells to store a matrix that has a trillion parameters. The set of readable cells 114 may be distributed in various layouts relative to the set of multipliers 102 and selection circuit 110.

The individual readable cells of the set of readable cells 114 may be configured in various ways in different applications. In some embodiments, the readable cells may be configured similarly to ROM cells. In some embodiments, a readable cell may include an access transistor and a programmed value. The access transistor may be used to control the flow of current and provide selective access to storage elements. When the access transistor is conductive, the value may be passed through the access transistor and read out by read circuit 112. When the access transistor is not conductive, the same read circuit 112 may be used to read a different value. The control node of the access transistor can be connected to a word line. A drain or source node of the access transistor can be coupled to the programmed value. The alternative drain or source node of the access transistor can be coupled to a bit line. The bit line can be connected to read circuit 112. The readable cell can be read by activating the word line and bit line associated with the access transistor.

In some embodiments, the set of readable cells 114 can be addressable by read circuit 112. Read circuit 112 can then be used to retrieve the store addresses associated with a given vector from the readable cells 114. For example, read circuit 112 can address a specific subset of readable cells to read the addresses required for a specific multiplication in parallel. Read circuit 112 can be configured to read the same set of readable cells 114 later when a different input value has been provided to the set of multipliers 102. Read circuit 112 can also be configured to read a different set of readable cells later when the same input value has been provided to the multiplier 102 to obtain the results of a different scalar-vector multiplication.

In some embodiments, read circuit 112 can be configured to read a first subset of the set of readable cells 114 associated with a first word line independently, and read a second subset of the set of readable cells 114 associated with a second word line independently. The configuration of read circuit 112 may resemble the methods used in standard ROM, RAM, or flash memories, where different sets of memory cells are typically connected to a word line and can be accessed either in parallel or individually using a bit line selection mechanism.

In some embodiments, the present system (e.g., system 100) may include an accumulator. The accumulator may be coupled to the output of selection circuit 110. When selection circuit 110 passes the product of an input value and a vector associated with the readable cells 114, the accumulator may accumulate the product with a stored value. In this way, matrix multiplication can be facilitated by conducting multiply-accumulate operations as the readable cells 114 are read in sequence and the resulting product values are accumulated in the accumulator. In some embodiments, the present system may include multiple selection circuits and accumulators so that a specific input can be multiplied by separate vectors and accumulated simultaneously.

In some embodiments, the present system (e.g., system 100) may include a parallel adder. The parallel adder may take in the output vectors from several selection circuits and add the values together in parallel. For example, the parallel adder may take in five large vectors of length X that are read from five selection circuits and add the corresponding parameters of each of the five vectors in a single clock cycle to produce an output vector. The output vector is of length X, including the sum of all those vectors. In this manner, the present system can be configured to perform the multiply and accumulate steps for matrix multiplication in a single clock cycle, which significantly speeds up the operation.

In some embodiments, the same readable cells 114 may be read and delivered to multiple selection circuits at the same time. Accordingly, multiple input values may be multiplied by the parameters associated with those readable cells, and the resulting products may be accumulated in parallel in a single clock cycle. In such cases, the present system may also include multiple sets of multipliers that can receive the different input values and deliver the resulting product values to their corresponding selection circuits. The resulting values may then be added together using a parallel adder in a single clock cycle or processed in parallel using separate accumulators in a single clock cycle.

In some embodiments, the present system (e.g., system 100) may include a control circuit to facilitate multiplying an input value 104 by multiple vectors. The control circuit may be configured to provide a first address to the set of readable cells 114 when the input 104 has a first value to generate a first product for selection circuit 110, and provide a second address to the set of readable cells 114 when the input 104 has the first value to generate a second product for selection circuit 110. Selection circuit 110 may be coupled to an accumulator that accumulates the first product and the second product. Using this approach, the control circuit, along with the selection circuit and the accumulator, can read out the values that are equal to a single input value multiplied by multiple vectors and accumulate the values. The control circuit can be configured to perform this operation similarly to how a microcontroller, core controller, or other control circuitry accesses specific addresses in a memory array, delivering an input operand to a computational clement as part of the standard operation of a computation pipeline.

In some embodiments, the present system (c.g., system 100) may include a control circuit to facilitate multiplying different input values 104 by a single vector. This control circuit may be configured to provide a first address to the set of readable cells 114 when the input 104 has a first value to generate a first product for read circuit 112, and provide the first address to the set of readable cells 114 when the input 104 has a second value to generate a second product for read circuit 112. Read circuit 112 may be coupled to an accumulator that accumulates the first product and the second product. Using this approach, this control circuit can read out or retrieve the values for multiplying two different input values 104 with a single vector and accumulate the retrieved values. The control circuit can be configured to perform this operation similarly to how a microcontroller, core controller, or other control circuitry accesses specific addresses in a memory array, delivering input operands to a computational element in the standard operation of a computation pipeline.

### Matrix Multiplication

The present system (e.g., system 100) may be applied to multiply any two matrices. The first matrix is of dimension A:B or A-by-B, with A rows and B columns. The second matrix is of dimension B:C or B-by-C, with B rows and C columns. A, B, and C are positive integers. In some embodiments, to multiply the first and second matrices, the present system may divide the first matrix into A matrices of size 1:B and configure the readable cells 114 such that the readable cells can store addresses associated with the values of the parameters in the second matrix of size B:C. Subsequently, the values in each of the A matrices of size 1:B can be delivered as inputs to the set of multipliers 102 in series. The values from the set of readable cells 114 can be read such that each of the B rows of the second B:C matrix are read independently while the inputs from a corresponding one of the matrices of size 1:B are provided as an input. The values that result from those B operations can be accumulated as they are read to obtain a 1:C vector, and the resulting values can then be saved in registers while the accumulator is used for the next operation. As soon as this process is repeated for each of the A matrices, the result is a matrix of size A:C, which is equal to the matrix multiplication of the first A:B matrix and the second B:C matrix.

In some embodiments, the second matrix of size B:C may include the model data of a machine intelligence model. The values of the model data generally remain fixed (e.g., after the model has been trained), allowing the system to be configured for computing inferences using the specific model. In some embodiments, the readable cells may be programmed using back end of line masks, such as the masks used for top-level metal or diffusion activation processes. This approach enables the present system to create an accelerator for machine intelligence models, in particular, the accelerator that can be customized for a specific machine intelligence model at a relatively low expense. This cost-effectiveness arises because the expense of fabricating masks for higher level metal layers is typically 10 to 100 times lower than that of masks for the underlying circuitry.

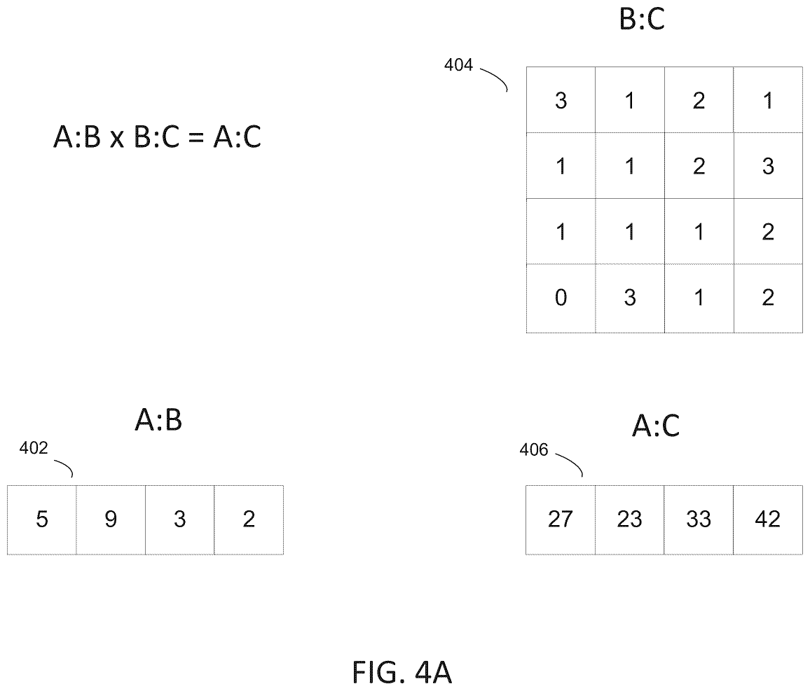

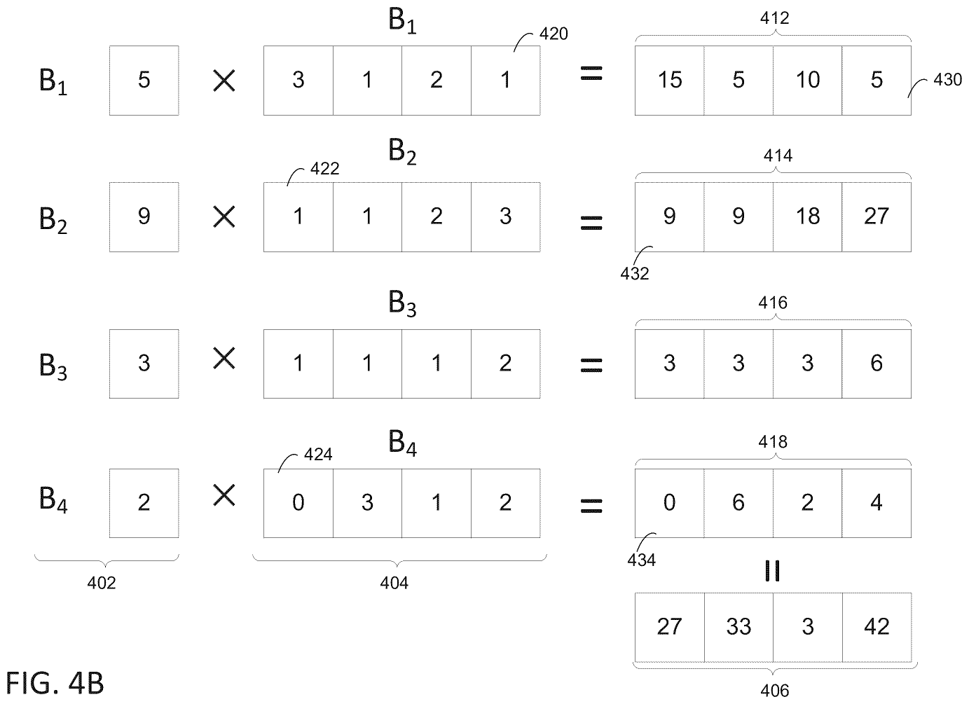

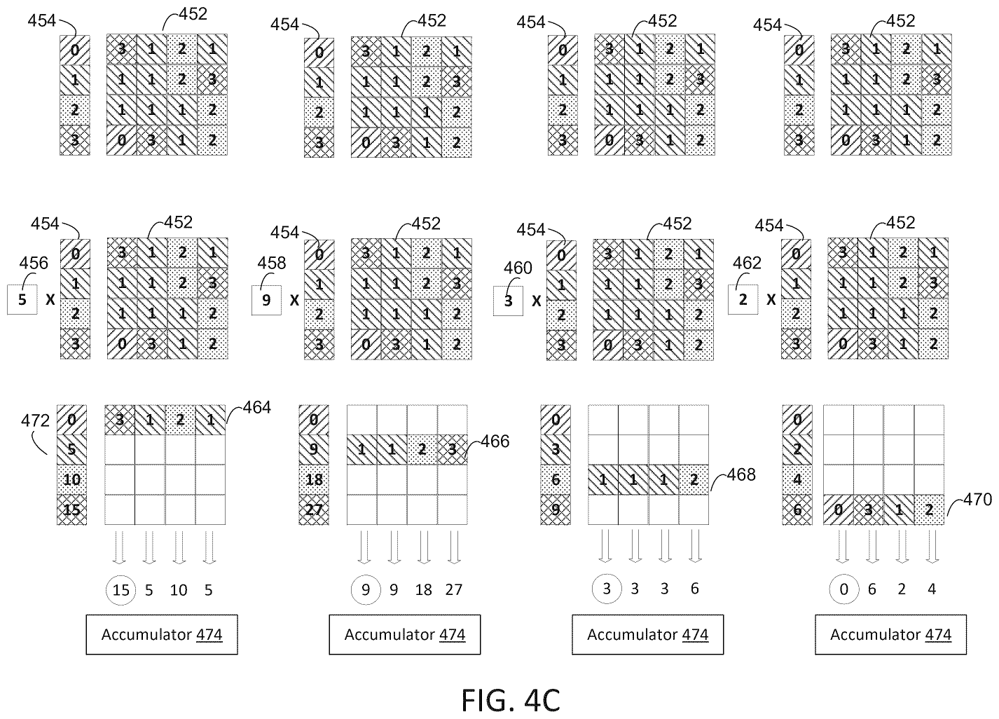

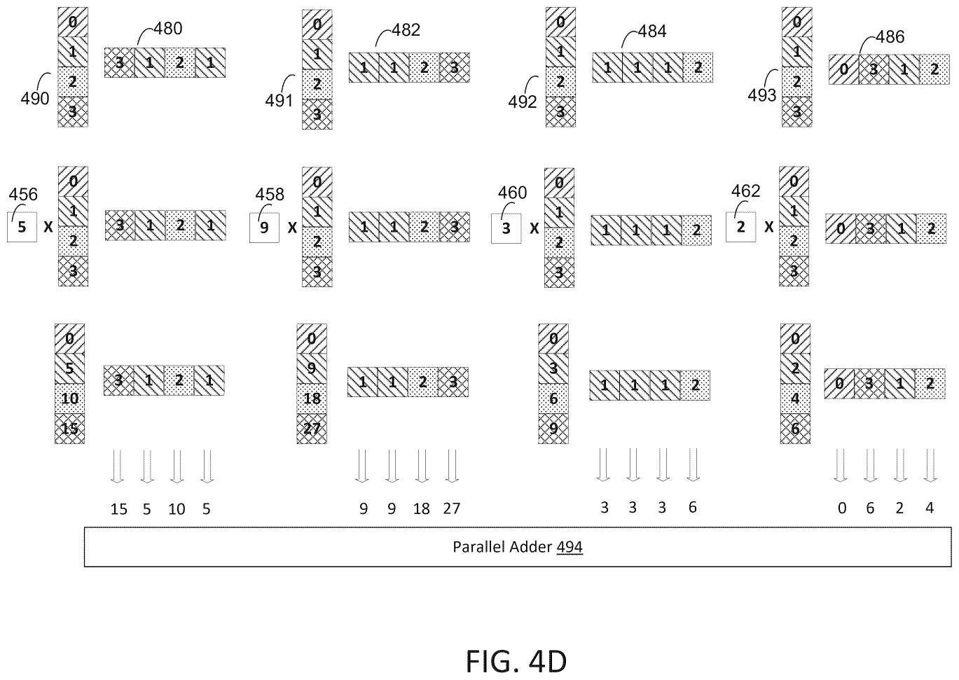

In some machine intelligence applications, the second matrix of size B:C in the above example may have an extremely large C value. However, the B value, determined by the input to the model layer(s), can typically be kept relatively low. As a result, the multiplication processes described above in the present system can beneficially be applied to machine intelligence applications. This is because the B value dictates the number of read operations that must be conducted, which impacts the computation time. The C value defines the size of the set of readable cells. Since the set of readable cells (e.g., 114) may be implemented using a single basic access transistor and storage element (e.g., a programmed storage transistor), the C value can be made very large at a minimal cost. As such, the present system is capable of conducting high-speed and cost-efficient machine intelligence matrix computations. This multiplication computation process will be further detailed below with reference to FIGS. 4A-4D.

Methods for configuring a system for matrix multiplication acceleration are provided herein. In some embodiments, a set of readable cells 114 may be provided. Each readable cell in the set of readable cells may be uniquely associated with a parameter of a vector. The readable cells may be programmed in a manner such that each readable cell in the set of readable cells is programmed with an address associated with a value of the parameter in an address space. For configuring the system for matrix multiplication acceleration, the methods continue with steps such as applying an input 104 to the set of multipliers 102, reading, using a read circuit 112, a set of addresses from the readable cells 114, and applying the set of addresses to a selection circuit 110 in order to select values from the set of multipliers 102.

Other steps may be included in the methods for configuring the system for matrix multiplication acceleration. For example, prior to applying the input 104, the values in the readable cells 114 may be programmed such that each readable cell in the set of readable cells 114 can store an address in an address space that is associated with the value of a parameter that is associated with that readable cell. Additionally, a number of multipliers required for the set of multipliers may be selected, for example, based on evaluating the values of the vectors to be multiplied.

### System Implementation with Serial or In-Parallel Output

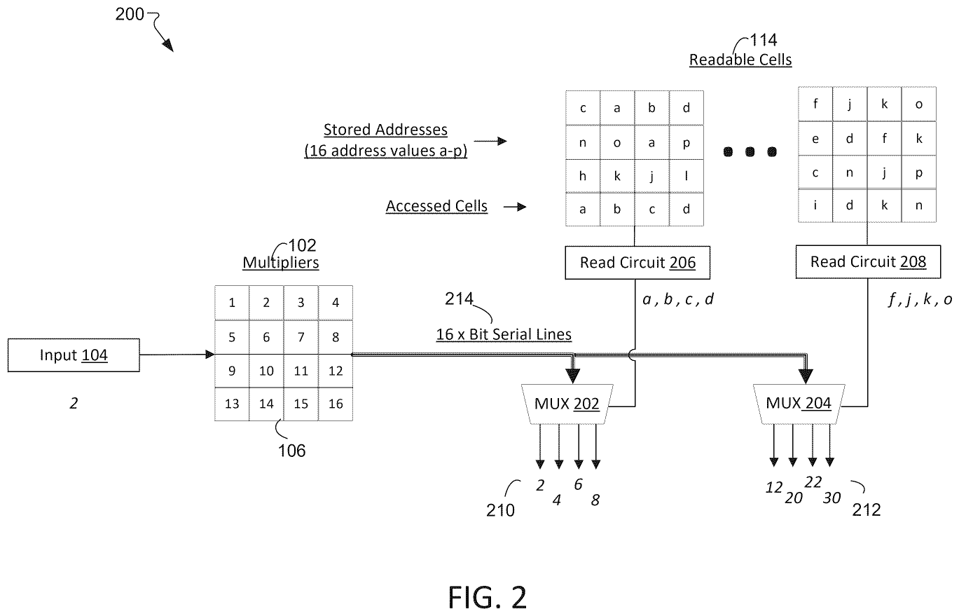

FIG. 2 is a block diagram of a system 200 for multiplying a matrix by a scalar in which the outputs are read bit serially, according to some embodiments. As illustrated, the selection circuit (e.g., selection circuit 110 in FIG. 1) is implemented by a pair of multiplexers 202 and 204. The set of readable cells 114 is segmented into 4-bit addresses, which can be read by a pair of read circuits 206 and 208. When a row of the readable cells 114 is read, the addresses in the row (e.g., the addresses “a, b, c, d” and “f, j, k, o”) are provided by read circuits 206 and 208 respectively to the control inputs of multiplexers 202 and 204. Under this control, multiplexer configurations are selected that route specific inputs in accordance with the address space to multiplexers 202 and 204, which causes the multiplexers to generate specific outputs. For example, the control input “a, b, c, d” from read circuit 206 may cause multiplier input values “1, 2, 3, 4” to be inputted to multiplexer 202 to produce an output “2, 4, 6, 8” in 210 (i.e., the multiplication result of “1, 2, 3, 4” with scalar input “2” in 104). Similarly, the control input “f, j, k, o” from read circuit 208 may cause multiplier input values “6, 10, 11, 15” to be inputted to multiplexer 204 to produce an output “12, 20, 22, 30” in 212. Since multiplexers 202 and 204 are fed with bit serial value lines from the set of multipliers 102 (e.g., 16× bit serial lines 214), the multiplication results 210 and 212 may be obtained bit serially from the outputs of multiplexer 202 and 204, respectively.

The selection circuit can be implemented by any number of multiplexers (including the example two multiplexers in FIG. 2), which is determined by the number of a subset of readable cells that is read at a given time. While in the illustrated example of FIG. 2, the set of readable cells 114 are segmented into 4-bit addresses, in alternative embodiments, system 200 may be configured to accelerate multiplication using addresses that have any number of bits. This number of bits may be determined depending on how many bits can be used to represent the parameter values in a matrix or how many potentially different values there are in that matrix.

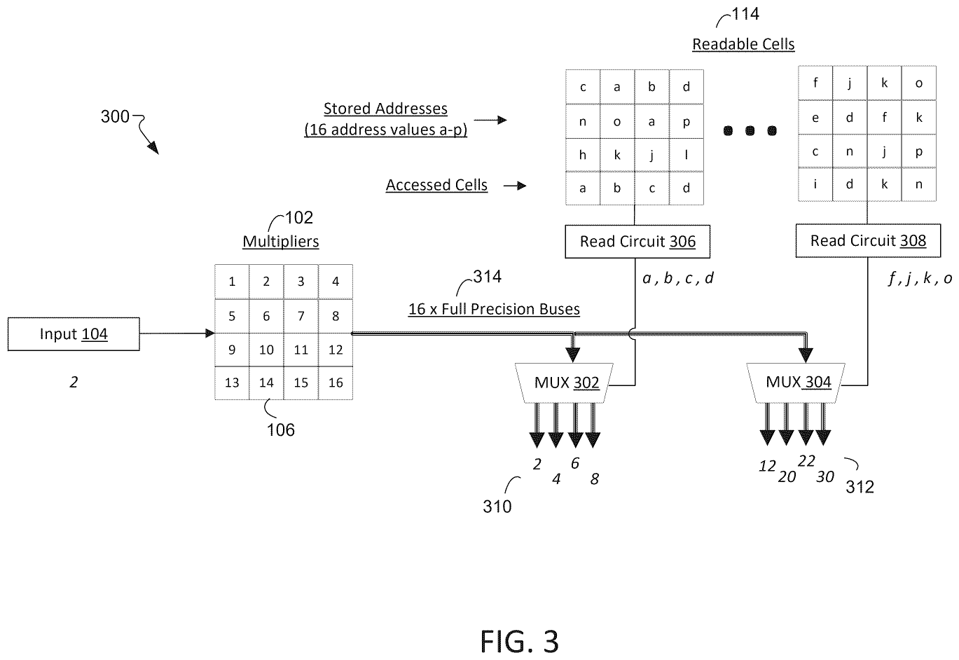

FIG. 3 is a block diagram of a system 300 for multiplying a matrix by a scalar in which the outputs are output fully in parallel, according to some embodiments. As illustrated, the selection circuits (e.g., selection circuit 110 in FIG. 1) can be implemented by two multiplexers 302 and 304. Compared to the multiplexers 202 and 204 in FIG. 2, multiplexers 302 and 304 depicted in FIG. 3 are more complex since each of these multiplexers 302 and 304 is able to pass full 4-bit precision values in parallel from one input to cause the generation of output upon receiving control inputs from read circuits 306 or 308. Similarly, the multiplier outputs of the set of multipliers 102, which are coupled to the inputs of multiplexers 302 and 304, are implemented as 16 full precision 4-bit buses 314 for moving all four of the bit values of cach multiplier output in parallel. As a result, a total of 16 bits of output values are delivered to the outputs 310 or 312 of each multiplexer in a given clock cycle.

### Example Matrix Multiplication Process

FIGS. 4A-4D illustrate an example matrix multiplication process, according to some embodiments. In particular, the benefits of multiplication acceleration is detailed in the example of FIGS. 4C and 4D.

FIG. 4A illustrates a matrix multiplication process in which a first matrix of size A:B is multiplied by a second matrix of size B:C to produce an output matrix A:C. In the depicted example, the first matrix 402 is a 1:4 matrix, where A=1 and B=4. The second matrix 404 is a 4:4 matrix, where B=4 and C=4. The matrix resulted from the multiplication of the first matrix 402 and the second matrix 404 is matrix 406 of size 1:4, where A=1 and C=4.

FIG. 4B illustrates the step-by-step matrix multiplication of FIG. 4A, where the multiplication is broken into vector multiplications using each of the scalars from the columns of the first matrix 402 against the vector rows of the second matrix 404, followed by the accumulation of the product results of the vector multiplications. The first step generally is to divide the first matrix of size A:B into A matrices of size 1:B. In this example, the first matrix 402 includes a single matrix of size 1:B=1:4 (since A=1). The values in this 1:4 matrix of [5 9 3 2] can be delivered in series to the set of multipliers as inputs. That is, values B₁=5, B₂=9, B₃=3, and B₄=2 are fed into, in sequence, as scalar input (e.g., 104) to multipliers (e.g., 102) to perform multiplications between these scalar inputs and vectors from the second matrix 404.

At the same time, readable cells (e.g., 114) may be configured to store addresses associated with the parameter values (four rows and four columns) in the second matrix 404. In particular, the configuration of readable cells may allow each of the four rows of the second matrix 404 to be read when a corresponding input from the first matrix 402 of size 1:4 is provided to the set of multipliers (e.g., 102). For example, when B₁=5 of the first matrix 402 is inputted, B₁ of the second matrix 404, i.e., the first row [3 1 2 1] is read. The first multiplication is performed at the set of multipliers to obtain the first value [15 5 10 5] in 412. When B₂=9 of the first matrix 402 is inputted, B₂ of the second matrix 404, i.e., the second row [1 1 2 3] is read, and the second multiplication is performed to obtain the second value [9 9 18 27] in 414. Similarly, B₃ and B₄ are inputted, which respectively cause the generation of two other multiplication values 416 and 418. The values 412, 414, 416, and 418 resulted from multiplication operations can then be accumulated to determine a 1:C (e.g., 1:4) vector in 406. In some embodiments, the elements at a specific position of each of 412, 414, 416, and 418 can be summed up to obtain the element in the corresponding position of the 1:C matrix in 406. For example, the first element in 406 is 15+9+3+0=27. Since the first matrix 402 in this example is also a vector (e.g., A=1), this 1:C vector is the final multiplication. However, if A is greater than one, this multiplication process will be repeated A times to obtain A matrices of size 1:C, which then forms a final A:C matrix representing the final result of a first matrix of size A:B being multiplied by a second matrix of size B:C.

It is noted that no multiplication operation is needed when there is a special operand of zero or one. In the example of FIGS. 4A and 4B, some of the parameter values (e.g., 420, 422) in the second matrix 404 are one. In such cases, a multiplier may not be needed. Instead, the system merely passes the other operand to the output (e.g., as in 430, 432). Additionally, when one of the parameter values (e.g., 424) in the second matrix 404 is zero, this zero is directedly passed to the output (e.g., 434) without a multiplier or a multiplication operation. The multiplication acceleration is further detailed below in FIGS. 4C and 4D.

FIGS. 4C and 4D illustrate how the systems disclosed herein (e.g., systems 100, 200, 300 in FIGS. 1-3) can be applied to conduct the multiplication operation shown in FIGS. 4A and 4B with minimal multiplications. In these figures, at least one side table is added, including all possible values of the parameters. Regardless of the size of the parameters (e.g., billions), the possible parameter values may fall within a manageable range (e.g., the size of all the potential parameter values may be 2ⁿ if the parameter values are represented by n-bits), leading to time-effective and cost-controllable multiplication with the possible values in the side table(s).

In FIG. 4C, the first row illustrates a set of readable cells 452 and a side table 454. The set of readable cells 452 stores addresses for the values of the second matrix 404 of size B:C shown in FIG. 4A, and side table 454 includes every potential value of the parameters in the second matrix 404. The same fill pattern for a cell and for an element of the side table shows that they are associated. That is, elements of side table 454 having a given value are associated with cells 452 storing addresses for parameters having that given value. The side table 454, in some embodiments, may include the multiplier outputs of a set of multipliers (e.g., 102). The second row illustrates how an input value (e.g., 456, 458, 460, or 462) can be input to side table 454. The input value may be from the first matrix 402 shown in FIG. 4A, which is provided as an input to the set of multipliers (e.g., 102). The other operand of the set of multipliers is the value in side table 454. The final row illustrates how a word line (e.g., 464, 466, 468, or 470) of the set of readable cells 452 can be read while one of the specific input values (e.g., 456, 458, 460, or 462) is provided to side table 454. This results in a vector product of a specific input value multiplied by the values of a vector of the second matrix 404. For example, when the first address of word line 464 is read, a selection circuit (e.g., 110) will obtain the value “15” from side table 472 based on the associations between the side tables and cell addresses (as reflected by the same fill pattern). This value is equal to the input of “5” multiplied by the value “3” of the first parameter of the second matrix 404. Using four iterations of such a process in this example, the full vector multiplication result can be computed by accumulating the values that are read out during each iteration in an accumulator 474. For example, the first element of the final vector multiplication result is 27, which is a sum of circled numbers 15, 9, 3, and 0.

The systems and methods disclosed herein are advantageous because the total number of multiplications will not expand exponentially when the dimension of the first matrix A:B and/or the dimension of the second matrix B:C increases. While the total number of multiplications in the example of FIG. 4C may still be the required 16, this number can be reduced to 8 since the multiplications of the input multiplied by 1 and 0 do not require multiplication operations. More importantly, this example is facile in that dimension C is likely to stretch into the millions, billions, or even higher (e.g., in machine intelligence applications), while the number of potential parameter values within dimension C will stay stable (e.g., if represented by 2-bits as shown here, the possible values include only 0, 1, 2, 3 in side table 454). As a result, the total number of multiplications (e.g., 16) will be limited to the number of potential parameter values (e.g., 4 values in side table 454) times the number of dimension B (e.g., B=4). In contrast, the number of multiplications otherwise required would scale up to the product of dimension B times dimension C (e.g., 4 billion).

Referring now to FIG. 4D, the multiplication operation is performed in parallel with minimal multiplications. The first row illustrates a set of readable cells and a set of side tables. The set of readable cells (e.g., 480, 482, 484, or 486) stores addresses for the values of the second matrix 404 of size B: C shown in FIG. 4A. The four side tables (e.g., 490, 491, 492, and 493) store every potential value of the parameters in the second matrix 404. FIG. 4D differs from FIG. 4C in that different physical elements used to perform the matrix multiplication (as shown in different sections of FIG. 4D) are all operating in parallel. For example, there are four side tables 490, 491, 492, and 493, and four different storage areas 480, 482, 484, and 486. The same fill pattern for a cell and for an element of a side table shows that they are associated. For example, elements of side table 490 having a given value are associated with cells 480 storing addresses for parameters having that given value. The side tables 490, 491, 492, and 493, in some embodiments, may include the multiplier outputs of multiple copies of the sets of multipliers (e.g., 102) disclosed above. The second row illustrates how a set of input values (e.g., 456, 458, 460, and 462) can be input to the side tables 490, 491, 492, and 493, respectively. The input values may be from the first matrix 402 shown in FIG. 4A, which can be provided as inputs to the sets of multipliers (e.g., 102). The other operands of the multipliers are the values in side table 490, 491, 492, or 493. The final row illustrates how all of the readable cells can be read in parallel while all of the input values (e.g., 456, 458, 460, and 462) are provided to the side tables (e.g., 490, 491, 492, and 493) simultaneously to obtain vector products of the input values multiplied by the values of the vectors of the second matrix 404.

As illustrated in FIG. 4D, during a single clock cycle all the products can be applied to a parallel adder 494 to produce the final value. In this example, the total number of multiplications required is 16, which is the same as that required in FIG. 4C. However, the approach described in FIG. 4D is performed four times faster. In addition, as noted above, the number of multiplications can be reduced to 8 since the multiplications of the input multiplied by 1 and 0 do not require multiplication operations. As such, by simply increasing the size of the side table hardware by a factor of four, which is likely to be a negligible change compared to the size of the readable cells, a substantial speedup can be achieved. In these embodiments, cach strip of the readable cells can be part of a larger set of readable cells that stores addresses for a different matrix. Each of these larger sets of readable cells can store addresses for matching, corresponding sets of matrices in order/sequence, such that computations can be conducted on cach of the matching sets of matrices in parallel.

### Additional Considerations

While the specification has been described in detail with respect to specific embodiments of the invention, it will be appreciated that those skilled in the art, upon attaining an understanding of the foregoing, may readily conceive of alterations to, variations of, and equivalents to these embodiments. Any of the method steps discussed above can be conducted by a processor operating with a computer-readable non-transitory medium storing instructions for those method steps. The computer-readable medium may be memory within a personal user device or a network accessible memory. Although examples in the disclosure were generally directed to machine intelligence applications, the same approaches could be utilized to other computationally intensive applications including cryptographic computations, ray tracing computations, and others. As another example, although examples in the disclosure were generally directed to computations in which multiplication operations must be conducted on a data structure with a number of parameters that is much larger than the potential values of those parameters, the same approaches can be used for different operations in place of the multiplication such as division, subtraction, addition, roots, logarithms, exponents, factorials, and any other mathematical or logical operation. These and other modifications and variations to the present invention may be practiced by those skilled in the art, without departing from the scope of the present invention, which is more particularly set forth in the appended claims.

### Terminology

The phraseology and terminology used herein is for the purpose of description and should not be regarded as limiting.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those clements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another clement having a same name (but for use of the ordinal term), to distinguish the claim elements.

Each numerical value presented herein, for example, in a table, a chart, or a graph, is contemplated to represent a minimum value or a maximum value in a range for a corresponding parameter. Accordingly, when added to the claims, the numerical value provides express support for claiming the range, which may lie above or below the numerical value, in accordance with the teachings herein. Absent inclusion in the claims, each numerical value presented herein is not to be considered limiting in any regard.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. The features and functions of the various embodiments may be arranged in various combinations and permutations, and all are considered to be within the scope of the disclosed invention. Accordingly, the described embodiments are to be considered in all respects as only illustrative and not restrictive. Furthermore, the configurations, materials, and dimensions described herein are intended as illustrative and in no way limiting. Similarly, although physical explanations have been provided for explanatory purposes, there is no intent to be bound by any particular theory or mechanism, or to limit the claims in accordance therewith.

What is claimed is:

1. A method for accelerating computational operations comprising:
multiplying, using a set of multiplier circuits, an input and a set of values associated with a set of parameters in a vector to produce a set of multiplier outputs;
storing, in a set of readable cells, a set of addresses that is associated with the set of values of the set of parameters;
reading, using a read circuit, the set of addresses stored in the set of readable cells for provision to a selection circuit; and
selecting, using the selection circuit, an output from the set of multiplier outputs corresponding to the set of parameters of the vector based on the set of addresses.

2. A system for accelerating computational operations comprising:
a set of multiplier circuits configured to receive an input and generate a set of multiplier outputs based on multiplying the input with a set of values associated with a set of parameters in a vector;
a set of readable cells configured to store a set of addresses that is associated with a set of values of the set of parameters in an address space;
a read circuit configured to read the set of readable cells; and
a selection circuit configured to receive the set of multiplier outputs and the set of addresses read by the read circuit, and produce an output using the set of multiplier outputs based on the set of addresses.

3. The system of claim 2, wherein the set of multiplier circuits is associated with each value in the vector in a one-to-one correspondence.

4. The system of claim 2, wherein the set of multiplier circuits is associated with each potential value of a parameter in the set of parameters in a one-to-one correspondence.

5. The system of claim 4, wherein:
the potential value of the parameter is an n-bit value, and
the set of multiplier circuits has a cardinality of two to a power of n (2ⁿ).

6. The system of claim 2, wherein the set of multiplier circuits comprises multipliers with fixed inputs and programmable inputs or multipliers with programmable inputs.

7. The system of claim 2, wherein:
the set of multiplier circuits comprises a set of serializers, and
the read circuit is further configured to include a set of deserializers.

8. The system of claim 2, wherein:
the set of multiplier circuits is a set of bit serial multipliers, and
the system further comprises a set of bit serial adders coupled to the read circuit.

9. The system of claim 2, wherein the set of multiplier circuits outputs a set of analog reference voltages to the set of readable cells.

10. The system of claim 2, further comprising a connectivity mesh interconnecting two blocks of circuitry of the set of multiplier circuits, the readable cells, the read circuit, and the selection circuit, wherein the connectivity mesh is configurable when the system is operational.

11. The system of claim 2, further comprising a connectivity mesh interconnecting two blocks of circuitry of the set of multiplier circuits, the readable cells, the read circuit, and the selection circuit, wherein the connectivity mesh is configurable when the system is being fabricated.

12. The system of claim 2, wherein:
the system is implemented on an integrated circuit, and
a connectivity mesh is formed in one or more metal layers of the integrated circuit to interconnecting the set of multiplier circuits, the readable cells, the read circuit, and the selection circuit.

13. The system of claim 2, wherein:
the set of readable cells is addressable by the read circuit, and
the read circuit is configured to read: (i) a first subset of the set of readable cells associated with a first word line independently, and (ii) a second subset of the set of readable cells associated with a second word line independently.

14. The system of claim 2, wherein each of the set of readable cells comprises an access transistor.

15. The system of claim 2, wherein:
the set of addresses is read by the read circuit in an order, and
the output produced by the selection circuit comprises one or more of multiplier outputs selected from the set of multiplier outputs based on a correspondence with the set of addresses in that order.

16. The system of claim 14, further comprising a parallel adder coupled to the selection circuit, wherein the parallel adder is configured to add the one or more of multiplier outputs from the selection circuit in a single clock cycle.

17. The system of claim 2, further comprising an accumulator coupled to the selection circuit, wherein the accumulator is configured to accumulate the output from the selection circuit with a stored value.

18. The system of claim 2, further comprising:
a control circuit configured to:
provide a first address to the set of readable cells when the input has a first value to generate a first product in the selection circuit; and
provide a second address to the set of readable cells when the input has a second value to generate a second product in the selection circuit; and
an accumulator coupled to the selection circuit and configured to accumulate the first product and the second product.

19. The system of claim 2, further comprising:
a control circuit configured to:
provide a first address to the set of readable cells when the input has a first value to generate a first product with the vector in the selection circuit; and
provide a second address to the set of readable cells when the input has the first value to generate a second product with a different vector in the selection circuit; and
an accumulator coupled to the selection circuit and configured to accumulate the first product and the second product.

20. The system of claim 2, wherein the selection circuit comprises one or more multiplexers.

21. A method for configuring a system for multiplication operation acceleration, the method comprising:
providing a set of readable cells, wherein each readable cell in the set of readable cells is uniquely associated with a parameter of a vector; and
configuring a connectivity mesh to allow each readable cell in the set of readable cells to be coupled to a multiplier via the connectivity mesh, wherein the multiplier is in a set of multipliers and inputted with a value of the parameter of the vector.

22. The method of claim 21, further comprising:
applying an input to the set of multipliers; and
reading, using a read circuit, a product of the input and the vector from the set of readable cells.

23. A method configuring a system for multiplication operation acceleration, the method comprising:
applying an input to a set of multipliers, wherein:
the set of multipliers are coupled to a set of readable cells using a connectivity mesh, and
each readable cell in the set of readable cells is: (i) uniquely associated with a parameter of a vector, and (ii) coupled, via the connectivity mesh, to a multiplier, wherein the multiplier is in a set of multipliers and inputted with a value of the parameter of the vector; and
reading, using a read circuit, a product of the input and the vector from the set of readable cells.

24. The method of claim 23, further comprising:
configuring, prior to applying the input, the connectivity mesh in a manner that each readable cell in the set of readable cells is coupled, via the connectivity mesh, to the multiplier.
